(19) United States
(12) Patent Application Publication
(10) Pub. No.: US 2007/0295433 A1
(43) Pub. Date: Dec. 27, 2007

(54) PNEUMATIC TIRE AND PROCES FOR MANUFACTURING THE TIRE

(76) Inventors: Piero Losi, Milano (IT); Pierluigi De Cancellis, Milano (IT); Gaetano Lo Presti, Milano (IT); Rodolfo Noto, Milano (IT); Claudio Lacagnina, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/572,064

(22) PCT Filed: Sep. 30, 2003
(86) PCT No.: PCT/IT03/00586

§ 371 Date: Jun. 7, 2007

(51) Int. Cl. B60C 11/14; B29D 30/10

(52) U.S. Cl. 152/209.5; 156/128.1

(57) ABSTRACT

A pneumatic tire includes a carcass structure, tread band, belt structure, and sidewalls. The carcass structure includes at least one carcass ply and at least one annular reinforcing structure associated with the at least one carcass ply. The tread band includes first and second sectors. The first sectors are axially spaced apart from each other and tapered along a radially inner direction. The second sectors are axially spaced apart from each other and tapered along a radially outer direction. The first and second sectors are disposed axially side-by-side, one after the other, along a transverse development of the tread band. A ratio of Shore A hardness at 23° C. of the elastomeric material of the first sectors to Shore A hardness at 23° C. of the elastomeric material of the second sectors is greater than 1.10:1. A process for manufacturing the tire is also disclosed.

### BACKGROUND OF THE INVENTION

The present invention relates to a pneumatic tire for two-wheeled or four-wheeled vehicles and in particular, but not exclusively, to a pneumatic tire for motorvehicles.

Specifically, the present invention refers to a pneumatic tire comprising a carcass structure having at least one carcass ply, and at least one annular reinforcing structure associated to said carcass ply, a tread band made of an elastomeric material at a radially outer position with respect to the carcass structure, a belt structure interposed between the carcass structure and the tread band and a pair of axially opposite sidewalls on the carcass structure, wherein the tread band is of the type comprising a plurality of axially adjacent sectors.

### PRIOR ART

In the field of pneumatic tires for vehicles one of the most felt needs is that of ensuring that the performances of the pneumatic tire and, in particular, its road holding, remain as constant as possible as the tread band inevitably wears down.

In known pneumatic tires, a performance alteration is almost invariably observed after a certain wear of the tread band.

Such a wear, in fact, reduces in the first place the height of the tread band determining a substantially proportional increase of the drift rigidity of the aforementioned band; in the second place and if the tread is patterned, the wear also modifies to an ever greater extent the geometry of the tread pattern and, more specifically, the extension of the area covered by the grooves formed in the tread band, generally proportional to the so-called sea/land ratio.

It should be specified herein that in the present description and in the subsequent claims, the term sea/land ratio is used to indicate the ratio between the area occupied by the grooves present in the tread band or in any portion thereof and the total area of the tread band or, respectively, of any portion thereof.

Generally speaking and due to the tapering of the grooves along a radially inner direction, the extension of the area covered by the grooves progressively decreases as the tire wears down with a corresponding increase of the transversal rigidity of the tread band and an altered behavior of the pneumatic tire on the road.

This increased transversal rigidity of the tread band, due to the thickness reduction of the tread band in grooveless pneumatic tires, and also due to a reduction of the sea/land ratio in patterned pneumatic tires, usually involves a greater thrust of the pneumatic tire at the same steer angle with a possible unbalancing between the front axle and the rear axle of the vehicle, the driver having in any case to change his/her driving style to compensate this different behavior of the pneumatic tire.

References are known which describe pneumatic tires provided with a tread band comprising a plurality of axially adjacent sectors.

In the field of pneumatic tires for motorcycles it was for example suggested by Japanese patent application JP 05-256646 to improve the tire performance along a curve by making a tread band provided with an equatorial portion having a lower hardness and a higher tangs as compared to those of opposite shoulder portions of the tread band itself.

On the other side, Japanese patent application JP 02-314293 has suggested, in order to prevent a partial wear of the tread band with the exfoliation of elastomeric material layers and the formation of cracks in the material, to realize a tread band provided with two radially superposed layers, each of which is in turn axially divided into two suitably shaped portions made of different materials. More specifically, the construction suggested by this document foresees that the two portions of each tread band layer have end segments having a reduced thickness at the equatorial plane of the pneumatic tire in such a way that the two portions of the layer may axially fit into one another.

In the field of anti-static pneumatic tires is was also suggested by U.S. Pat. No. 6,523,585 to improve the wear uniformity of the tread band and to reduce the noisiness of the pneumatic tire, by realizing a tread band comprising a plurality of axially adjacent sectors respectively made of an electrically insulating elastomeric material and of an electrically conducting elastomeric material. According to the teachings of this reference, the aforementioned electrically insulating and electrically conducting elastomeric materials must have specific mechanical characteristics and, in particular, a respective hardness such that the ratio between the Shore A hardness at room temperature of the electrically conducting sectors and the Shore A hardness at room temperature of the electrically insulating sectors must be less than 1.10.

Problem Underlying the Invention

The present invention has the object of providing a pneumatic tire provided with a tread band comprising a plurality of axially adjacent sectors which allows to maintain substantially constant the road holding of the pneumatic tire as the tread band wears down.

### SUMMARY OF THE INVENTION

According to a first aspect of the invention, this object is achieved by a pneumatic tire as defined in attached claim 1.

The Applicant has, in particular, found that thanks to a particular combination of a specific geometric structure of the axially adjacent sectors of the tread band with specific mechanical characteristics of these sectors it is possible to obtain a tread band which is capable to compensate the increase of transversal rigidity of geometric nature due to the wear of the tread band and proportional to the thickness reduction of the band and, in the case of a patterned pneumatic tire, also to the reduction of the sea/land ratio with a progressive increase in the transversal deformability of the portions of elastomeric material defined between the grooves along a radially inner direction.

More specifically, the Applicant has found that the aforementioned object can be achieved thanks to a tread band comprising:
i) a plurality of first sectors axially spaced apart and tapered along a radially inner direction, and
ii) a plurality of second sectors axially spaced apart and tapered along a radially outer direction,
   wherein said first and second sectors are axially positioned side-by-side one after the other along the transversal development of the tread band, and
   wherein the ratio between the Shore A hardness at 23° C. of the first sectors, measured according to standard DIN 53505, and the Shore A hardness at 23° C. of the second sectors, measured according to standard DIN 53505, is greater than 1.10.

The Applicant, while not wishing to be bound by any interpretative theory, observes that with the increase along the radially inner direction of the width of the second sectors consisting of a less rigid vulcanized elastomeric material, it is possible to effectively achieve the aforementioned effect of counterbalancing the transversal rigidity increase with a suitable composition of the tread band.

The pneumatic tire thus allows to maintain substantially constant the road behavior of the pneumatic tire in particular as far as its response to trajectory corrections set by the driver by means of the steering wheel is concerned, avoiding a possible unbalancing between the front axle and the rear axle of the vehicle and allowing the driver not to significantly change his/her driving style.

This technical effect is particularly appreciated by those who adopt a so-called “up-to-the-limit” driving style.

In a preferred embodiment of the invention, the ratio between the Shore A hardness at 23° C. of the first sectors, measured according to standard DIN 53505, and the Shore A hardness at 23° C. of the second sectors, measured according to standard DIN 53505, is comprised between about 1.12 and about 1.70 and, still more preferably, between about 1.20 and about 1.40.

In this way, is was advantageously possible to achieve an optimal compromise between the performance in terms of road holding as wear increases and the other performances required to the pneumatic tire, such as for example driving comfort, noise, wear resistance and smoothness.

Preferably and in order to achieve the aforementioned ratios, the Shore A hardness at 23° C. of the first sectors, measured according to standard DIN 53505, is comprised between about 60 and about 75, whereas the Shore A hardness at 23° C. of the second sectors, measured according to standard DIN 53505, is comprised between about 35 and about 65.

By observing the aforementioned values of Shore A hardness of the tapered and axially adjacent sectors of the tread band, it has been found that it is possible to compensate in an optimal way the transversal rigidity increase due to the thickness reduction of the tread band and, in the case of patterned pneumatic tires, also due to a reduction of the sea/land ratio as a consequence of the tread band wear of the pneumatic tire, with a gradual increase of the portions of the less rigid elastomeric material which get in touch with the ground.

Still more preferably, the Shore A hardness at 23° C. of the first sectors, measured according to standard DIN 53505, is comprised between about 65 and about 70, whereas the Shore A hardness at 23° C. of the second sectors, measured according to standard DIN 53505, is comprised between about 50 and about 60.

For the purposes of the invention, the tapered and axially adjacent sectors of the tread band can be obtained by forming and vulcanizing suitable elastomeric materials the composition of which can be easily determined by a man skilled in the art so as to achieve the aforementioned desired Shore A hardness values at 23° C.

It should be specified herein that in the present description and in the subsequent claims, the term “elastomeric material” is used to indicate a composition comprising at least one elastomeric polymer and at least one reinforcing filler. Preferably, such a composition also comprises additives such as, for example, a cross-linking agent and/or a plasticizer. Thanks to the presence of the cross-linking agent, such a material may be cross-linked by heating, so as to form the end product.

Preferably, the first sectors tapered along the radially inner direction of the tread band have a modulus of elasticity (E′) under compression at 23° C. comprised between about 7 and about 13 MPa, whereas the second sectors, axially spaced apart and tapered along the radially outer direction have a modulus of elasticity (E′) under compression at 23° C. comprised between about 5 and about 8 MPa.

In the following description and in the subsequent claims, the values of the modulus of elasticity E′ under compression, as well as the viscous modulus E″, are intended to be measured by means of conventional apparatuses by submitting a cylindrical test piece of vulcanized elastomeric material having a length of 25 mm and a diameter of 14 mm, subjected to compression preloading up to a longitudinal deformation of 25% of its original height and kept at a temperature of 23° C., to a dynamic sinusoidal deformation of a maximum width of ±3.50% of the height under preloading, with a frequency of 100 cycles per second (100 Hz).

By observing the aforementioned values of the modulus of elasticity under compression E′ at 23° C. of the tapered sectors of the tread band, it has been found that it is advantageously possible to compensate in an optimal way the transversal rigidity increase both for grooveless and patterned pneumatic tires, achieving an optimal compromise between the performances in terms of wear of the tread band of the pneumatic tire and in terms of resistance to the transversal stresses which the tire is subjected to mainly during running along a curve or in mixed courses.

More preferably, the aforementioned first sectors of the tread band have a modulus of elasticity (E′) under compression at 23° C. comprised between about 9 and about 11 MPa, whereas the second sectors of the tread band have a modulus of elasticity (E′) under compression at 23° C. comprised between about 5.5 and about 7 MPa.

In a preferred embodiment of the invention, the ratio between the modulus of elasticity

E′ under compression at 23° C. of the first sectors and the modulus of elasticity E′ under compression at 23° C. of the second sectors of the tread band is greater than about 1.15 and, still more preferably, is comprised between about 1.4 and 2.0.

Also in this case, it has been noted that by observing such ratios it is advantageously possible to achieve an optimal compromise between the performances in terms of wear of the tread band of the pneumatic tire and in terms of resistance to the transversal stresses which the tire is subjected to mainly during running along a curve or in mixed courses.

According to a preferred embodiment of the invention, the tapered and axially adjacent sectors of the tread band are axially distributed one after the other with a substantially constant pitch along the transversal development of the tread band.

Within the framework of the present description and in the subsequent claims, the term “pitch” of the tapered and axially adjacent sectors of the tread band, is used to indicate the distance measured within a cross-section and along the axial direction between the middle axes of two consecutive sectors. Within the framework of the present definition, the middle axis of each sector is the axis which divides in two substantially equal parts the radially inner and the radially outer faces of the sector itself.

Thanks to the aforementioned axial distribution of the tread band sectors, it is advantageously possible to maintain the transversal rigidity of the tread band at substantially uniform values substantially along the entire axial development thereof.

According to a preferred embodiment of the invention, the tapered and axially adjacent sectors of the tread band are provided with axially opposite side walls defining a tapering angle measured with respect to a plane extending substantially perpendicularly to the radially inner and radially outer faces of the sectors comprised between about 30° and about 80°.

It has been found that in such a way it is advantageously possible to optimize the gradual increase of the yield along the transversal direction of the portions of elastomeric material defined between the grooves to compensate both the thickness reduction of the tread band and the possible reduction of the sea/land ratio deriving from the tread band wear of the pneumatic tire.

The Applicant has found that the side walls of the tapered and axially adjacent sectors of the tread band can have different geometric shapes provided that the desired tapering is maintained along radially opposite directions of the adjacent sectors.

Thus, in a first preferred embodiment, the axially opposite side walls of the tapered and axially adjacent sectors of the tread band can be substantially rectilinear.

Alternatively, the axially opposite side walls of the tapered and axially adjacent sectors of the tread band can be provided with at least one substantially curvilinear portion.

The man skilled in the art can easily select among these possible configurations the most appropriate or the most advantageous one as a function of the production methods adopted for the manufacture of the tread band.

As stated above, the pneumatic tire of the invention can be used to equip both two-wheeled and four-wheeled vehicles.

Within the framework of these possible uses and according to a preferred embodiment, the pneumatic tire of the invention comprises a tread band provided with a tread pattern in which the grooves defined therein are formed in the sectors of the tread band tapered along a radially inner direction and consisting of a more rigid elastomeric material.

Alternatively, the grooves defined in the tread pattern can be formed in the sectors of the tread band tapered along a radially outer direction and consisting of a more yielding elastomeric material.

Although the positioning of the grooves of the tread pattern is not critical for the purposes of the invention, arranging the grooves in the sectors consisting of the same type of elastomeric material and, still more preferably, in the sectors tapered along a radially inner direction consisting of the more rigid elastomeric material, is preferable to limit down to a minimum the occurrence of phenomena of irregular wear of the tread band.

In a preferred embodiment of the invention, the tapered and axially adjacent sectors of the tread band are radially extending substantially for the entire thickness of the tread band, so as to achieve the desired technical effect of maintaining the characteristics of transversal rigidity substantially for the whole useful life of the pneumatic tire.

In an alternative preferred embodiment of the invention, the pneumatic tire can be further provided with a layer of a suitable elastomeric material placed between the tread band and the belt structure.

In such a way, it is advantageously possible to optimize—if desired—specific characteristics of the pneumatic tire such as, for example, the rolling resistance.

According to a further aspect of the invention, a process for manufacturing a pneumatic tire is provided as defined in attached claim 16.

Such a process comprises, in particular, the steps of:
a) manufacturing a carcass structure having at least one carcass ply associated to at least one annular reinforcing structure;
b) making a belt structure;
c) arranging, at a radially outer position with respect to said belt structure, a plurality of first sectors of a tread band, axially spaced apart, tapered along a radially inner direction and substantially consisting of a first elastomeric material having after vulcanization a predetermined value of the Shore A hardness at 23° C., measured according to standard DIN 53505;
d) arranging, at a radially outer position with respect to said belt structure, a plurality of second sectors of the tread band, axially spaced apart, tapered along a radially outer direction and substantially consisting of a second elastomeric material having after vulcanization a value of the Shore A hardness at 23° C., measured according to standard DIN 53505 such that the ratio between the Shore A hardness at 23° C. of the first elastomeric, measured according to standard DIN 53505 material and the Shore A hardness at 23° C. of the second elastomeric material, measured according to standard DIN 53505, is greater than 1.10;
   wherein steps c) and d) are carried out in such a way that said first and second sectors of the tread band are axially positioned side-by-side one after the other along the transversal development of the tread band.

### BRIEF DESCRIPTION OF THE DRAWINGS

Additional features and advantages of the invention will be better apparent from the following description of some preferred embodiments of pneumatic tires and of processes for their manufacture according to the invention, which description is made by way of non limiting indication, with reference to the attached drawings, wherein:

FIG. 1 shows a cross-section view of a first embodiment of a pneumatic tire according to the present invention;

FIG. 2 shows an enlarged scale cross-section view of some details of the pneumatic tire of FIG. 1;

FIG. 3 shows an enlarged scale cross-section view of some details of a second embodiment of a pneumatic tire according to the present invention;

FIG. 4 shows a schematic plan view of a robotized station for making the tread band of the pneumatic tire according to the invention;

FIG. 5 shows a schematic plan view of a robotized station for making the tread band of the pneumatic tire according to the invention on a substantially cylindrical auxiliary drum;

FIG. 6 shows a schematic perspective view of a robotized station for making the tread band of the pneumatic tire according to the invention on a substantially rigid toroidal support.

### DETAILED DESCRIPTION OF THE PREFERRED EMBODIMENTS

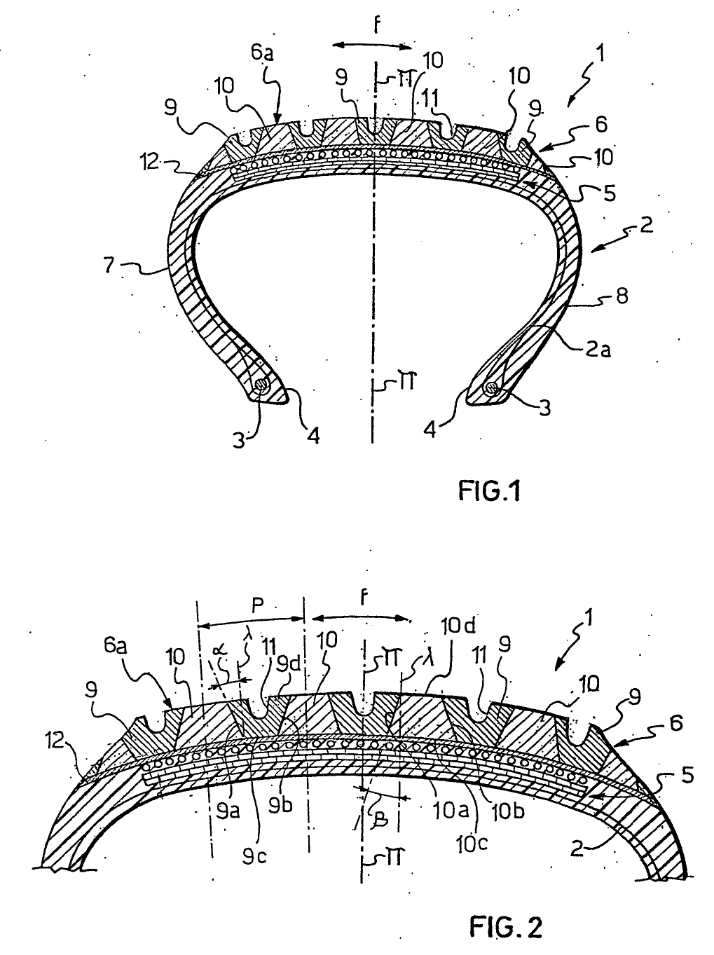

With reference to FIGS. 1-2, a pneumatic tire made according to a first preferred embodiment of the invention, which in the specific example is intended to equip a motorvehicle, is generally indicated at 1.

The pneumatic tire 1 comprises a carcass structure 2 provided with at least one carcass ply 2a the opposite side edges of which are externally folded up around respective annular reinforcing structures 3, usually known as “bead cores”, each enclosed in a bead 4 defined along an inner circumferential edge of the pneumatic tire 1 and at which the pneumatic tire itself engages on a rim (not shown) forming part of the wheel of a vehicle.

The pneumatic tire 1 also comprises a tread band 6 made of an elastomeric material at a radially outer position with respect to the carcass structure 2, a belt structure 5 interposed between the carcass structure 2 and the tread band 6 and a pair of sidewalls 7, 8 in axially opposite positions on the carcass structure 2.

Preferably, the belt structure 5 includes one or more belt layers made for example with a fabric of metal cords or wires embedded in a rubber sheet, arranged parallel to each other in each layer and crossed with respect to those of the adjacent layer and with one or more so-called 0° cords spirally and coaxially wound on the pneumatic tire 1 at a radially outer position with respect to the crossed cord fabrics.

According to the embodiment illustrated in FIG. 1, the tread band 6 circumferentially applied around the belt structure 5 comprises a plurality of first sectors 9 axially spaced apart and tapered along a radially inner direction and a plurality of second sectors 10, axially spaced apart and tapered along the opposite direction, i.e. along a radially outer direction.

Preferably, the first and second sectors 9, 10 of the tread band 6 are radially extending substantially for the entire thickness of the tread band itself.

The aforementioned first and second sectors 9, 10 are axially positioned side-by-side one after the other along the transversal development of the tread band 6 and are made of suitable different elastomeric materials such that the ratio between the Shore A hardness at 23° C. of the sectors 9, measured according to standard DIN 53505, and the Shore A hardness at 23° C. of the sectors 10, measured according to standard DIN 53505, is greater than 1.10 and, more preferably, comprised between about 1.12 and about 1.70 and, still more preferably, comprised between about 1.20 and about 1.40.

Preferably and in order to achieve the aforementioned ratios, the Shore A hardness at 23° C., measured according to standard DIN 53505, of the first sectors 9 is comprised between about 60 and about 75, whereas the Shore A hardness at 23° C., measured according to standard DIN 53505, of the second sectors 10 is comprised between about 35 and about 65.

More preferably, the Shore A hardness at 23° C. of the first sectors 9, measured according to standard DIN 53505, is comprised between about 65 and about 70, whereas the Shore A hardness at 23° C. of the second sectors 10, measured according to standard DIN 53505, is comprised between about 50 and about 60.

Preferably, the first sectors 9 of the tread band 6 have a modulus of elasticity (E′) under compression at 23° C. comprised between about 7 and about 13 MPa, whereas the second sectors 10 have a modulus of elasticity (E′) under compression at 23° C. comprised between about 5 and about 8 MPa.

More preferably, the first sectors 9 of the tread band 6 have a modulus of elasticity (E′) under compression at 23° C. comprised between about 9 and about 11 MPa, whereas the second sectors 10 have a modulus of elasticity (E′) under compression at 23° C. comprised between about 5.5 and about 7 MPa.

In this way, the first and second sectors 9, 10 of the tread band 6, tapered and axially positioned side-by-side, advantageously allow thanks to their different geometric and mechanical characteristics to maintain substantially constant the transversal rigidity of the tread band 6 as it wears down and allow to achieve an optimum compromise between the performances in terms of wear of the tread band 6 and the resistance to the transversal stresses which the tread is subjected to mainly during running along a curve or in mixed courses.

The tread band 6 thus made is provided with a radially outer surface 6a arranged to get in touch with the ground and usually equipped with a tread pattern comprising a plurality of grooves 11 which define a plurality of rubber ribs and rubber blocks.

According to a preferred feature of the invention, the first and second sectors 9, 10 of the tread band 6 are axially distributed one after the other with a substantially constant pitch p along the transversal development of the tread band 6.

Preferably, moreover, the first and second sectors 9, 10 of the tread band 6 are substantially trapezoidal and are provided with axially opposite side walls 9a, 9b and 10a, 10b defining respective tapering angles α, β measured with respect to a plane λ—extending substantially perpendicularly to the radially inner faces 9c, 10c and to the radially outer faces 9d, 10d of the sectors—comprised between about 30° and about 80°.

Preferably, the axially opposite side walls 9a, 9b and 10a, 10b of said first and second sectors 9, 10 of the tread band 6 are substantially rectilinear.

Alternatively, the axially opposite side walls 9a, 9b and 10a, 10b of the tapered and axially adjacent sectors of the tread band can be provided with at least one substantially curvilinear portion.

The man skilled in the art can easily select among these possible configurations the most appropriate or the most advantageous one as a function of the production methods adopted for the manufacture of the tread band.

Preferably, furthermore, the grooves 11 are formed in the first sectors 9 of the tread band 6 so as to limit down to a minimum the occurrence of phenomena of irregular wear of the tread band.

In the preferred embodiment illustrated in FIGS. 1 and 2, finally, the pneumatic tire 1 further comprises a layer 12 of a suitable elastomeric material interposed between the tread band 6 and the belt structure 5.

Although the pneumatic tire 1 of this preferred embodiment has been illustrated with just one layer including the tapered and axially adjacent sectors 9, 10, this does not mean that the tread band 6 cannot comprise two or more radially superposed layers in order to satisfy specific and contingent application requirements.

Clearly, moreover, the number and width of the transversal development of the first and second sectors 9, 10 of the tread band 6 can be different with respect to those exemplified for merely illustrating and not limiting purposes in FIGS. 1 and 2 and can be easily determined by a man skilled in the art according to specific application requirements of the pneumatic tire 1.

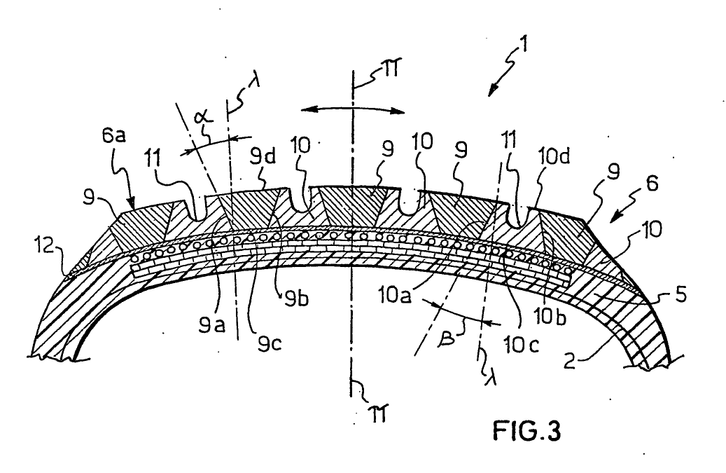

In FIG. 3 a further preferred embodiment of the pneumatic tire 1 of the invention is illustrated.

In the following description and in such figures, the elements of the pneumatic tire 1 which are structurally or functionally equivalent to those previously illustrated with reference to the embodiment shown in FIGS. 1-2 will be indicated with the same reference numerals and will not be described any further.

In the embodiment illustrated in FIG. 3, the grooves 11 are formed in the second sectors 10 of the tread band 6, so as to achieve also in this case substantially the same overall technical effects of the pneumatic tire 1 illustrated in FIGS. 1 and 2.

In the following example, provided for indicating and not limiting purposes, some formulations of preferred elastomeric materials which can be used for making the first and second sectors 9, 10 of the tread band 6 of a pneumatic tire according to the invention shall now be indicated.

### EXAMPLE

Elastomeric materials have been prepared, designated with A and B in the following Table 1, which can be used for making the first and second sectors 9, 10 according to the present invention of the tread band 6. In the Table, all of the amounts are expressed in phr.

TABLE 1

| | material A | material B |
|---|---|---|
| Ingredients | (first sectors 9) | (second sectors 10) |
| E-SBR 1712 | 70 | 70 |
| E-SBR 1500 | 30 | 30 |
| carbon black N234 | 30 | 25 |
| SiO₂ | 35 | 30 |
| SiO₂ binding agent | 7 | 6 |
| aromatic oil | 10 | 18 |
| stearic acid | 1.5 | 1.5 |
| ZnO | 2.5 | 2.5 |
| 6PPD | 2 | 2 |
| DPG | 1 | 1 |
| TBBS | 1.5 | — |
| CBS | — | 1.5 |
| soluble sulfur | 1.3 | 1 |

The ingredients used were the following:
E-SBR 1712=butadiene-styrene copolymer prepared in emulsion commercially available with the trade name of KRYNOL®1712 (BAYER);
E-SBR 1500=butadiene-styrene copolymer prepared in emulsion commercially available with the trade name of KRYLENE®1500 (BAYER);
carbon black N234=a product available on the market with the trade name of VULCAN®7H (CABOT CORPORATION);
SiO₂=silica available on the market with the trade name of ULTRASIL® VN3 (DEGUSSA);
SiO₂ binding agent=solid composition including 50% carbon black (N330), 50% bis(3-triethoxysilyl-propyl)tetrasulfide commercially available with the trade name of X50S (DEGUSSA);
aromatic oil=a product available on the market with the trade name of MOBILOIL®90 (MOBIL);
stearic acid=a product available on the market with the trade name of STEARINA®TP8 (MIRACHEM);
ZnO=a product available on the market with the trade name of ZINKOXYD AKTIV® (BAYER);
6PPD=N-1,3-dimethylbutyl-N′-phenyl-p-phenylendiamine available on the market with the trade name of VULCANOX®4020 (BAYER);
DPG=diphenylguanidine, available on the market with the trade name of VULKACIT®D (BAYER);
TBBS=N-t-butyl-2-benzothiazyl-sulfenamide, available on the market with the trade name of VULKACIT®NZ (BAYER);
   CBS=N-cyclohexyl-2-benzothiazyl-sulfenamide, available on the market with the trade name of VULKACIT®CZ (BAYER);
   soluble sulfur=a product available on the market with the trade name of RUBERSUL®400 (REPSOL DERIVADOS).

According to techniques conventional per se and known in the art, the aforementioned elastomeric materials were subjected to vulcanization and then to a series of tests having the purpose of measuring some typical parameters of the vulcanized materials. The parameters taken into consideration were the following:
SHORE A hardness=measured at 23° C. according to standard DIN 53505;
E′ 23° C.=modulus of elasticity under compression measured at 23° C. according to the procedure described hereinabove;
Tangδ 23° C.=ratio between the viscous modulus (E″) and the modulus of elasticity (E′) measured at 23° C. according to the procedure described hereinabove;
CA 1=traction force (referred to the section of the test piece) to have a deformation of 100%, measured according to standard DIN 53504;
CA 3=traction force (referred to the section of the test piece) to have a deformation of 300%, measured according to standard DIN 53504.

The results of the tests carried out are shown in the following Table 2.

TABLE 2

| | material A | material B |
|---|---|---|
| Parameter | (first sectors 9) | (second sectors 10) |
| SHORE A hardness | 70 | 55 |
| E′ 23° C. [MPa] | 10.2 | 6.0 |
| Tangδ 23° C. | 0.290 | 0.250 |
| CA 1 [MPa] | 3.26 | 1.57 |
| CA 3 [MPa] | 14.7 | 7.6 |

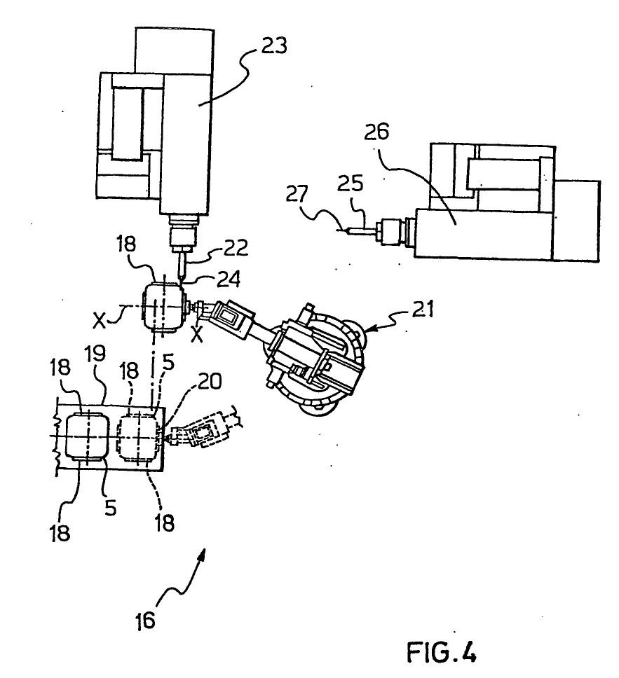

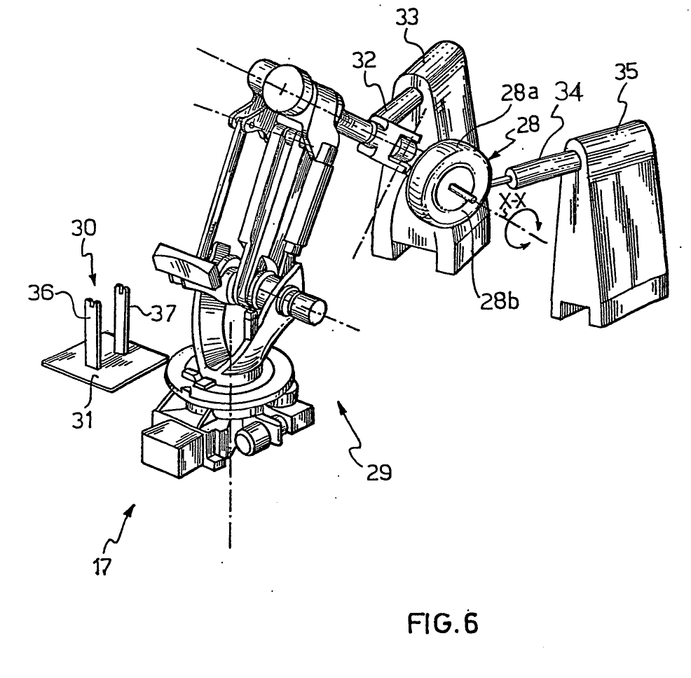

With reference to FIGS. 4, 5 and 6, respective work stations shall now be described, generally indicated at 16 in FIGS. 4 and 5 and 17 in FIG. 6, intended to make the tread band 6 with axially adjacent sectors of the pneumatic tire 1 within the framework of preferred embodiments of the manufacturing process according to the invention.

In the embodiment illustrated in FIG. 4, a robotized work station intended to manufacture the tread band 6 of the pneumatic tire 1 illustrated in FIG. 1 is generally indicated at 16.

The work station 16 is associated to a conventional manufacturing plant for the production of pneumatic tires, or for carrying out part of the working operations foreseen in the production cycle of the pneumatic tires themselves, plant otherwise not illustrated being known per se.

In such a plant, apparatuses known per se and not illustrated are also present for manufacturing the carcass structure 2 and the annular reinforcing structure 3 associated thereto on a supporting element capable to assume a substantially toroidal configuration, such as for example a manufacturing drum 18 known per se, as well as for subsequently forming the belt structure 5 in a radially outer position with respect to the carcass structure 2.

The work station 16 comprises a robotized arm known per se, generally indicated at 21 and preferably of the anthropomorphic type with seven axes, intended to pick up each drum 18 supporting the carcass structure 2, the annular reinforcing structure 3 and the belt structure 5 from a pick up position 20, defined at the end of a conveyor belt 19 or other suitable transporting means, to a delivery position of the sectors 9, 10 of the tread band 6.

More specifically, the delivery position of the sectors 9 tapered along a radially inner direction of the tread band 6 is defined at a first delivery member 22 of an extruder 23, adapted to provide at least one first continuous elongated element consisting of an elongated element 24 made of a suitable elastomeric material having a suitable size in s cross-section, whereas the delivery position of the sectors 10 tapered along a radially outer direction of the tread band 6 is defined at a second delivery member 25 of an extruder 26, adapted to provide at least one second continuous elongated element consisting of an elongated element 27 also consisting of a suitable elastomeric material having a suitable size in cross section.

With reference to the work station 16 described above and to FIG. 4, a first preferred embodiment of the process for manufacturing a pneumatic tire of this invention shall now be described.

In a series of preliminary steps carried out upstream of the work station 16, the carcass structure 2 comprising the annular reinforcing structure 3 and the belt structure 5 are 15 manufactured and shaped on the drum 18 which assumes and then determines a substantially toroidal shape of the pneumatic tire under construction. Said drum 18 is then transported by the conveyor belt 19 to the pick up position 20.

In a subsequent step, the robotized arm 21 positions the drum 18 in the first delivery position defined at the first delivery member 22 of the elongated element 24 made of the first elastomeric material having after vulcanization a predetermined Shore A hardness at 23° C. and intended to form the sectors 9 of the tread band 6 tapered along a radially inner direction.

In such a delivery position, the robotized arm 21 rotates the drum 18 about its rotation axis X-X and carries out a relative displacement between the delivery member 22 and the drum 18 by also imparting to the latter a translational movement along a direction substantially parallel to the aforementioned rotation axis X-X.

Concurrently with the rotation and translation movement of the drum 18 the first delivery member 22 delivers the elongated element 24 at a radially outer position with respect to the belt layer 5 so as to form the sectors 9 of the tread band 6.

Advantageously, the rotation and translation movement of the drum 18 is suitably driven in such a way as to form a plurality of sectors 9 axially spaced apart by the predetermined pitch p.

Preferably, the delivery of the elongated element 24 is carried out by forming a plurality of coils axially arranged side-by-side and/or radially superposed so as to define the sectors 9.

In a subsequent step, the robotized arm 21 positions the drum 18 in the second delivery position defined at the second delivery member 25 of the elongated element 27 made of the second elastomeric material intended to form the sectors 10 of the tread band 6 tapered along a radially outer direction and having after vulcanization a Shore A hardness such that the ratio between the Shore A hardness at room temperature, measured according to standard DIN 53505 of the first vulcanized elastomeric material and the Shore A hardness at room temperature, measured according to standard DIN 53505 of this second vulcanized elastomeric material is greater than 1.10.

Also in this second delivery position, the robotized arm 21 rotates the auxiliary drum 18 about its rotation axis X-X and carries out a relative displacement between the delivery member 25 and the auxiliary drum 18 also imparting to the latter a translational movement along a direction substantially parallel to the aforementioned rotation axis X-X.

Concurrently with the rotation and translation movement of the auxiliary drum 18, the second delivery member 25 delivers the elongated element 27 at a radially outer position with respect to the belt layer 5 so as to form the sectors 10 of the tread band 6 between the sectors 9 previously formed.

Also in this case, the rotation and translation movement of the drum 18 is suitably driven so as to form a plurality of sectors 10 axially spaced apart by the predetermined pitch p.

Also in this step, the delivery of the elongated element 27 is preferably carried out by forming a plurality of coils axially arranged side-by-side and/or radially superposed.

At the end of this second deposition step, the tread band 6 of the green pneumatic tire being manufactured may be deemed to be complete for which reason the drum 18 is transported in a way known per se and not shown to the subsequent work stations of the plant.

According to the invention, the deposition sequence of the sectors 9, 10 is not critical, for which reason it is also possible to foresee that the sectors 10 are formed before the sectors 9 at a radially outer position with respect to the belt layer 5.

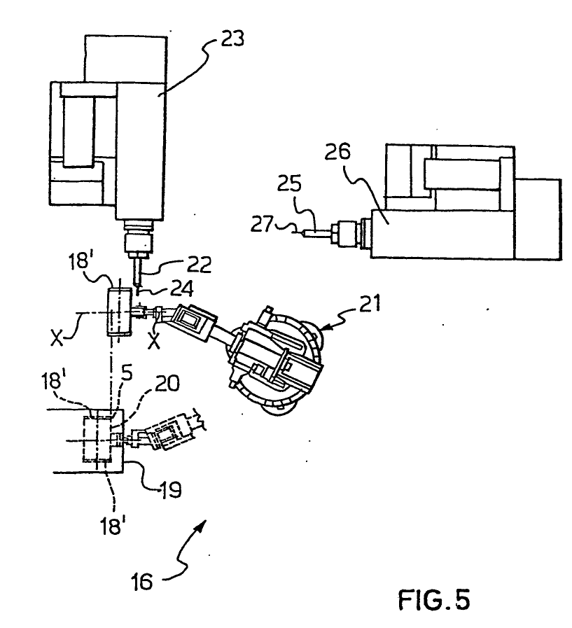

In a variant of the previous embodiment of the process according to the invention, illustrated with reference to FIG. 5, a substantially cylindrical auxiliary drum 18′ is used on which the belt structure 5 is assembled. The auxiliary drum 18′ is moved substantially in the same way as the drum 18 previously illustrated.

More precisely, the auxiliary drum 18′ is positioned at the first delivery member 22 of the first elastomeric material; subsequently, an elongated element 24 of said first elastomeric material is delivered by the delivery member 22 onto the belt structure 5, preferably carrying out a relative displacement between the first delivery member 22 and the auxiliary drum 18′ so as to form the sectors 9 of the tread band 6 tapered along a radially inner direction.

Subsequently, the auxiliary drum 18′ is positioned at the second delivery member 25 of the second elastomeric material, and an elongated element 27 delivered by the member 25 is deposited on the belt structure 5, preferably carrying out a relative displacement between the second delivery member 25 and the auxiliary drum 18′ so as to form the sectors 10 of the tread band 6 between the sectors 9 previously formed.

Also in this embodiment, the steps of delivering the aforementioned elongated elements of elastomeric material are preferably carried out by rotating the auxiliary drum 18′ about its rotation axis.

Similarly, the aforementioned delivering steps are carried out by forming a plurality of coils axially arranged side-by-side and/or radially superposed so as to define the first and second sectors 9, 10 of the tread band 6.

Preferably, finally, the relative displacement between the delivery members 22 and 25 and the auxiliary drum 18′ is carried out by imparting to the auxiliary drum 18′ a translational movement along a direction substantially parallel to its rotation axis.

Also in this case, the deposition sequence of the sectors 9, 10 is not critical, for which reason it is possible to foresee that the sectors 10 are formed before the sectors 9 at a radially outer position with respect to the belt layer 5.

At the end of the deposition of the tread band 6, the belt structure-tread band assembly is associated to the remaining parts of the pneumatic tire being manufactured waiting on a different manufacturing drum. The subsequent shaping of the pneumatic tire finally allows to obtain the green pneumatic tire to be vulcanized.

These preferred embodiments of the process according to the invention have, in particular, an advantageous and effective application when it is desired to exploit a conventional production line, making use indeed of at least one manufacturing drum on which the semifinished products which shall constitute the pneumatic tire are at least partially formed, said conventional production line being integrated with a final robotized station for manufacturing the tread band with axially adjacent sectors described above.

In the embodiment illustrated in FIG. 6, a work station intended to manufacture the tread band 6 of the pneumatic tire 1 is generally indicated at 17.

The work station 17 is in particular associated to a highly automated plant for manufacturing pneumatic tires, or for carrying out part of the working operations foreseen in the production cycle of the pneumatic tires themselves, a plant otherwise not illustrated being known per se.

Within the framework of these working operations it is advantageously foreseen to manufacture the different parts of the pneumatic tire 1 directly on a support 28, substantially toroidal and preferably substantially rigid, having an outer surface 28a, 28b substantially shaped according to the inner configuration of the pneumatic tire itself.

Within such a plant, robotized stations not illustrated herein are also present for manufacturing on the toroidal support 28 the carcass structure 2 comprising the annular reinforcing structure 3 and for the subsequent formation of the belt structure 5 at a radially outer position with respect to the carcass structure 2.

The work station 17 comprises a robotized arm known per se, generally indicated at 29 and preferably of the anthropomorphic type with seven axes, intended to pick up each support 28 carrying the carcass structure 2, the annular reinforcing structure 3 and the belt structure 5 from a pick up position 30, defined at the end of two supporting arms 36, 37 of a trestle 31 or other suitable supporting means, to a delivery position of the sectors 9 and 10 of the tread band 6.

More specifically, the delivery position of the sectors 9 of the tread band 6 tapered along a radially inner direction is defined at a first delivery member 32 of an extruder 33, adapted to provide at least one first continuous elongated element consisting of an elongated element (not visible in FIG. 6) made of a suitable first elastomeric material having a suitable size in cross section, whereas the delivery position of the sectors 10 of the tread band 6 tapered along a radially outer direction is defined at a second delivery member 34 of an extruder 35, adapted to provide at least a second continuous elongated element consisting of an elongated element (also not visible in FIG. 6) consisting of a suitable second elastomeric material having a suitable size in cross section.

Further structural and functional details of the robotized arm 29 are for example described in International patent application WO 00/35666 in the name of the present Applicant, the description of which is herein incorporated by reference.

With reference to the work station 17 described above and to FIG. 6, a further preferred embodiment of the process for manufacturing a pneumatic tire of this invention shall now be described.

In a series of preliminary steps carried out upstream of the work station 17 in a series of robotized stations, the carcass structure 2, the annular reinforcing structure 3 and the belt structure 5 are manufactured on the toroidal support 28 which is then transported to the pick up position 30.

In a subsequent step, the robotized arm 29 positions the toroidal support 28 in the first delivery position defined at the first delivery member 32 of the elongated member consisting of the first elastomeric material having after vulcanization a predetermined Shore A hardness at 23° C. and intended to form the sectors 9 of the tread band 6.

In such a delivery position, the robotized arm 29 rotates the support 28 about its rotation axis X-X and carries out a relative displacement between the delivery member 32 and the support 28 also imparting to the latter a translational movement along a direction substantially parallel to the aforementioned rotation axis X-X.

Simultaneously with the rotation and translation movement of the support 28 the first delivery member 32 delivers the elongated element at a radially outer position with respect to the belt layer 5 so as to form the sectors 9 of the tread band 6.

Preferably, the delivery of the elongated element is carried out by forming a plurality of coils axially arranged side-by-side and/or radially superposed so as to define the sectors 9.

In a subsequent step, the robotized arm 29 positions the support 28 in the second delivery position defined at the second delivery member 34 of the elongated element consisting of the second elastomeric material having after vulcanization a Shore A hardness such that the ratio between the Shore A hardness at room temperature, measured according to standard DIN 53505 of the first vulcanized elastomeric material and the Shore A hardness at room temperature, measured according to standard DIN 53505 of this second vulcanized elastomeric material is greater than 1.10.

Also in this second delivery position, the robotized arm 29 rotates the support 28 about its rotation axis X-X and carries out a relative displacement between the delivery member 34 and the support 28 also imparting to the latter a translational movement along a direction substantially parallel to the aforementioned rotation axis X-X.

Simultaneously with the rotation and translation movement of the support 28 the second delivery member 34 delivers the elongated element at a radially outer position with respect to the belt layer 5 so as to form the sectors 10 of the tread band 6 between the sectors 9 previously formed.

Also in this case, the delivery of the elongated element is preferably carried out by forming a plurality of coils axially arranged side-by-side and/or radially superposed.

Also in this case, the deposition sequence of the sectors 9, 10 is not critical, for which reason it is possible to foresee that the sectors 10 are formed before the sectors 9 at a radially outer position with respect to the belt layer 5.

At the end of this second deposition step, the tread band 6 of the green pneumatic tire being manufactured may be deemed to be complete for which reason the support 28 is transported, in a way known per se and not shown, to the subsequent work stations of the plant.

This different preferred embodiment of the process according to the invention has in particular an advantageous and effective application when it is desired to use production techniques which allow to minimize or, possibly, eliminate the production and storage of the semifinished products, for example by adopting process solutions which allow to make the individual components by directly applying them on the pneumatic tire being manufactured according to a predetermined sequence by means of a plurality of robotized stations.

Repeated tests carried out by the Applicant have shown that that the pneumatic tires according to the invention fully achieve the object of maintaining substantially constant the road holding as the tread band wears down.

1-26. (canceled)

27. A pneumatic tire, comprising:
a carcass structure;
a tread band;
a belt structure; and
a pair of sidewalls;
wherein the carcass structure comprises at least one carcass ply,
wherein the carcass structure further comprises at least one annular reinforcing structure associated with the at least one carcass ply,
wherein the tread band comprises elastomeric material,
wherein the tread band is disposed at a radially outer position with respect to the carcass structure,
wherein the belt structure is interposed between the carcass structure and the tread band,
wherein the sidewalls are disposed in axially opposite positions on the carcass structure,
wherein the tread band comprises:
a plurality of first and second sectors;
wherein the first sectors are axially spaced apart from each other,
wherein the first sectors are tapered along a radially inner direction,
wherein the second sectors are axially spaced apart from each other,
wherein the second sectors are tapered along a radially outer direction,
wherein the first and second sectors are disposed axially side-by-side, one after the other, along a transverse development of the tread band, and
wherein a ratio of Shore A hardness at 23° C. of the elastomeric material of the first sectors, measured according to standard DIN 53505, to Shore A hardness at 23° C. of the elastomeric material of the second sectors, measured according to standard DIN 53505, is greater than 1.10:1.

28. The tire of claim 27, wherein the ratio of the Shore A hardness at 23° C. of the elastomeric material of the first sectors, measured according to standard DIN 53505, to the Shore A hardness at 23° C. of the elastomeric material of the second sectors, measured according to standard DIN 53505, is greater than or equal to about 1.12:1 and less than or equal to about 1.70:1.

29. The tire of claim 27, wherein the Shore A hardness at 23° C. of the elastomeric material of the first sectors, measured according to standard DIN 53505, is greater than or equal to about 60 and less than or equal to about 75.

30. The tire of claim 27, wherein the Shore A hardness at 23° C. of the elastomeric material of the second sectors, measured according to standard DIN 53505, is greater than or equal to about 35 and less than or equal to about 65.

31. The tire of claim 27, wherein the elastomeric material of the first sectors has a modulus of elasticity under compression at 23° C. greater than or equal to about 7 MPa and less than or equal to about 13 MPa.

32. The tire of claim 31, wherein a ratio of the modulus of elasticity under compression at 23° C. of the elastomeric material of the first sectors to a modulus of elasticity under compression at 23° C. of the elastomeric material of the second sectors is greater than or equal to about 1.15:1.

33. The tire of claim 31, wherein a ratio of the modulus of elasticity under compression at 23° C. of the elastomeric material of the first sectors to a modulus of elasticity under compression at 23° C. of the elastomeric material of the second sectors is greater than or equal to about 1.4:1 and less than or equal to about 2.0:1.

34. The tire of claim 27, wherein the elastomeric material of the second sectors has a modulus of elasticity under compression at 23° C. greater than or equal to about 5 MPa and less than or equal to about 8 MPa.

35. The tire of claim 34, wherein a ratio of a modulus of elasticity under compression at 23° C. of the elastomeric material of the first sectors to the modulus of elasticity under compression at 23° C. of the elastomeric material of the second sectors is greater than or equal to about 1.15:1.

36. The tire of claim 34, wherein a ratio of a modulus of elasticity under compression at 23° C. of the elastomeric material of the first sectors to the modulus of elasticity under compression at 23° C. of the elastomeric material of the second sectors is greater than or equal to about 1.4:1 and less than or equal to about 2.0:1.

37. The tire of claim 27, wherein the first and second sectors are axially distributed one after the other with a substantially constant pitch along the transverse development of the tread band.

38. The tire of claim 27, wherein the first and second sectors comprise axially opposite sidewalls defining a tapering angle, measured with respect to a plane extending substantially perpendicular to radially inner and radially outer faces of the first and second sectors, greater than or equal to about 30° and less than or equal to about 80°.

39. The tire of claim 38, wherein the axially opposite sidewalls of the first and second sectors are substantially rectilinear.

40. The tire of claim 38, wherein the axially opposite sidewalls of the first and second sectors comprise at least one substantially curvilinear portion.

41. The tire of claim 27, wherein the tread band further comprises a tread pattern,
wherein the tread pattern comprises a plurality of grooves, and
wherein the grooves are formed in the first sectors.

42. The tire of claim 27, wherein the tread band further comprises a tread pattern,
wherein the tread pattern comprises a plurality of grooves, and
wherein the grooves are formed in the second sectors.

43. The tire of claim 27, wherein the first and second sectors extend in a radial direction substantially for an entire thickness of the tread band.

44. The tire of claim 27, further comprising a layer of a suitable elastomeric material interposed between the tread band and the belt structure.

45. A process for manufacturing a pneumatic tire, comprising:
making a carcass structure comprising at least one carcass ply and at least one annular reinforcing structure associated with the at least one carcass ply;
making a belt structure;
disposing a plurality of first sectors of a tread band at first radially outer positions with respect to the belt structure; and
disposing a plurality of second sectors of the tread band at second radially outer positions with respect to the belt structure;
wherein the first sectors are axially spaced apart from each other,
wherein the first sectors are tapered along a radially inner direction,
wherein the first sectors substantially consist of a first elastomeric material having, after vulcanization, a first value of Shore A hardness at 23° C., measured according to standard DIN 53505,
wherein the second sectors are axially spaced apart from each other,
wherein the second sectors are tapered along a radially outer direction,
wherein the second sectors substantially consist of a second elastomeric material having, after vulcanization, a second value of Shore A hardness at 23° C., measured according to standard DIN 53505,
wherein a ratio of the Shore A hardness at 23° C. of the first elastomeric material to the Shore A hardness at 23° C. of the second elastomeric material is greater than 1.10:1, and
wherein disposing the plurality of first and second sectors is carried out so that the first and second sectors are disposed axially side-by-side, one after the other, along a transverse development of the tread band.

46. The process of claim 45, wherein the belt structure is made on a substantially cylindrical auxiliary drum,
wherein disposing the plurality of first sectors comprises:
positioning the auxiliary drum at a first delivery member of the first elastomeric material; and
delivering, using the first delivery member, at least one elongated element made of the first elastomeric material on the belt structure while carrying out a relative displacement between the first delivery member and the auxiliary drum so as to form the first sectors of the tread band, axially spaced apart and tapered along a radially inner direction; and
wherein disposing the plurality of second sectors comprises:
positioning the auxiliary drum at a second delivery member of the second elastomeric material; and
delivering, using the second delivery member, at least one elongated element made of the second elastomeric material on the belt structure while carrying out a relative displacement between the second delivery member and the auxiliary drum so as to form the second sectors of the tread band, axially spaced apart and tapered along a radially outer direction.

47. The process of claim 46, wherein the relative displacement between the respective delivery member and the auxiliary drum is carried out by imparting to the auxiliary drum:
a first translational movement along a direction substantially parallel to a rotation axis of the auxiliary drum,
a second translational movement along a direction substantially perpendicular to the rotation axis, or
the first translational movement along the direction substantially parallel to the rotation axis and the second translational movement along the direction substantially perpendicular to the rotation axis.

48. The process of claim 46, wherein delivering the at least one elongated element made of the first elastomeric material and delivering the at least one elongated element made of the second elastomeric material are carried out by rotating the auxiliary drum about a rotation axis of the auxiliary drum.

49. The process of claim 48, wherein the relative displacement between the respective delivery member and the auxiliary drum is carried out by imparting to the auxiliary drum:
a first translational movement along a direction substantially parallel to a rotation axis of the auxiliary drum,
a second translational movement along a direction substantially perpendicular to the rotation axis, or
the first translational movement along the direction substantially parallel to the rotation axis and the second translational movement along the direction substantially perpendicular to the rotation axis.

50. The process of claim 46, wherein delivering the at least one elongated element made of the first elastomeric material and delivering the at least one elongated element made of the second elastomeric material are carried out by forming a plurality of coils axially arranged side-by-side, radially superposed, or side-by-side and radially superposed to define the first and second sectors of the tread band.

51. The process of claim 45, wherein the belt structure is made on a substantially toroidal support,
wherein disposing the plurality of first sectors comprises:
positioning the substantially toroidal support at a first delivery member of the first elastomeric material; and
delivering, using the first delivery member, at least one elongated element made of the first elastomeric material at a radially outer position with respect to the belt structure while carrying out a relative displacement between the first delivery member and the substantially toroidal support so as to form the first sectors of the tread band, axially spaced apart and tapered along the radially inner direction; and
wherein disposing the plurality of second sectors comprises:
positioning the substantially toroidal support at a second delivery member of the second elastomeric material; and
delivering, using the second delivery member, at least one elongated element made of the second elastomeric material at a radially outer position with respect to the belt structure while carrying out a relative displacement between the second delivery member and the substantially toroidal support so as to form the second sectors of the tread band, axially spaced apart and tapered along the radially outer direction.

52. The process of claim 51, wherein the relative displacement between the respective delivery member and the substantially toroidal support is carried out by imparting to the substantially toroidal support:
a first translational movement along a direction substantially parallel to a rotation axis of the substantially toroidal support,
a second translational movement along a direction substantially perpendicular to the rotation axis, or
the first translational movement along the direction substantially parallel to the rotation axis and the second translational movement along the direction substantially perpendicular to the rotation axis.

53. The process of claim 51, wherein delivering the at least one elongated element made of the first elastomeric material and delivering the at least one elongated element made of the second elastomeric material are carried out by rotating the substantially toroidal support about a rotation axis of the substantially toroidal support.

54. The process of claim 53, wherein the relative displacement between the respective delivery member and the substantially toroidal support is carried out by imparting to the substantially toroidal support:
a first translational movement along a direction substantially parallel to a rotation axis of the substantially toroidal support,
a second translational movement along a direction substantially perpendicular to the rotation axis, or
the first translational movement along the direction substantially parallel to the rotation axis and the second translational movement along the direction substantially perpendicular to the rotation axis.

55. The process of claim 51, wherein delivering the at least one elongated element made of the first elastomeric material and delivering the at least one elongated element made of the second elastomeric material are carried out by forming a plurality of coils axially arranged side-by-side, radially superposed, or side-by-side and radially superposed to define the first and second sectors of the tread band.

56. The process of claim 51, wherein the substantially toroidal support is substantially rigid.
